(19) United States
(12) Patent Application Publication
(10) Pub. No.: US 2026/0278158 A1
(43) Pub. Date: Sep. 17, 2026

(54) SYSTEM AND METHOD FOR ELECTRONICALLY COMMUNICATING PROTECTED ACCESSIBLE USER DATA TO AN AUTHORIZED THIRD PARTY

(71) Applicant: Eric Frohnapple, Houston, TX (US)

(72) Inventor: Eric Frohnapple, Houston, TX (US)

(73) Assignee: Eric Frohnapple, Houston, TX (US)

(21) Appl. No.: 19/673,194

(22) Filed: May 11, 2026

Related U.S. Application Data
(63) Continuation-in-part of application No. 18/440,862, filed on Feb. 13, 2024, now Pat. No. 12,626,010.

(51) Int. Cl. G06F 21/62; G06F 21/64; H04L 9/32

(52) U.S. Cl. CPC G06F 21/6245; G06F 21/64; H04L 9/3226

(57) ABSTRACT

The present disclosure provides a system and a method for electronically communicating protected accessible data of a user to an authorized third party, are described. The system enables the user to authorize access to the protected accessible data by the third party while preventing access to data that is not authorized. The system presents an interface that facilitates the user to provide the protected accessible data including a plurality of personal identification documents of the user. Upon receiving an access request from the authorized third party the user selects the plurality of personal identification documents by checking the boxes corresponding to the plurality of personal identification documents for viewing by the authorized third party. The system enables the user to provide an access code corresponding to the selected personal identification document facilitating the authorized third party to access the selected personal identification document.

### CROSS-REFERENCE TO RELATED APPLICATION

This application is a continuation-in-part of U.S. patent application Ser. No. 18/440,862 filed on Feb. 13, 2024, titled “SYSTEM AND METHOD FOR ELECTRONICALLY COMMUNICATING PROTECTED ACCESSIBLE USER DATA TO AN AUTHORIZED THIRD PARTY,” which is herein incorporated by reference.

### FIELD OF THE DISCLOSURE

The present disclosure relates generally to the field of data security and document handling, more specifically, to a system and a method for providing controlled access to information required by third parties, while preventing access to information that is not authorized for such parties.

### BACKGROUND

The importance of data privacy in personal identification documents extends beyond individual concerns to encompass broader societal, legal, and security considerations. Implementing robust security measures and respecting privacy rights help mitigate the risks associated with the collection and storage of sensitive personal information. Personal identification documents, such as passports, driver's licenses, social security cards, vehicle registration documents and other documents, but not limited to government-issued identity documents (IDs), contain sensitive information that can be used to uniquely identify individuals. Ensuring the privacy and security of the personal data is crucial for several reasons including prevention of identity theft, protection of personal safety, privacy rights, financial security and legal and regulatory compliance. Government agencies often collect personal data from individuals for various reasons, and these purposes are generally tied to the fulfillment of their responsibilities and functions. Historically, personal data of a user was provided to agencies via a printed document. Increasingly, technology is enabling digital versions of evidence that is accessible on mobile devices. Digital versions of evidence has advantages such as reducing costs and impacts from printing, keeping information current, and reducing confusion caused by loss of documents remains a challenge. The risk of moving the personal data to mobile devices or other digital devices or systems create the potential for breach of privacy and identify theft. For example, when the mobile devices are unlocked to access the personal data, data not relevant to the approved personal data can be accessed without further authorization.

Accordingly, there remains a need to address the aforementioned technical drawbacks in providing a system and method to provide information of protected accessible data of the user while securing and preventing access to non-disclosed data.

### SUMMARY

The present disclosure provides a technical solution for selectively disclosing personal identification information to authorized third parties while preserving privacy and restricting access to non-required information. The disclosed system enables a user to control which personal identification documents and selected data attributes are shared in response to an access request, and further enables generation of verification determinations using only the selected data attributes without exposing additional personal information associated with the personal identification documents. The system further improves security and data handling efficiency by limiting disclosure duration and reducing unnecessary exposure of personal data during verification and authentication processes.

According to one aspect, the present disclosure provides a system for electronically communicating protected accessible data of a user to an authorized third party. The system comprises a user device associated with the user and a computing apparatus communicatively coupled to the user device, comprising a memory storing a set of instructions; and one or more processors configured to execute the set of instructions for electronically communicating protected accessible data of the user to the authorized third party. The processors are configured to render, on the user device, a user interface configured to receive protected accessible data associated with the user, the protected accessible data comprising a plurality of personal identification documents of the user, storing, within the database, the generated authorization credentials in association with the protected accessible data, generate, for each of the plurality of personal identification documents of the user, one or more authorization credentials comprising: an access code, a personal identification number (PIN), a password, a biometric authentication, or any combination thereof, to enable an authorized third party to access the selected personal identification documents, receive an access request for the protected accessible data of the user from the authorized third party for providing one or more services to the user, enable the user to select one or more of the plurality of personal identification documents for viewing by the authorized third party, enable the user to select one or more data attributes from the selected personal identification documents for disclosure to the authorized third party while withholding remaining data attributes of the selected personal identification documents from the authorized third party, and enable the user to provide authorization by providing one or more authorization credentials, for enabling the authorized third party to access the selected personal identification documents with select one or more data attributes while preventing access to unauthorized data. The personal identification document comprises information associated with one or more eligibility, qualification, status, or authorization criteria. The unauthorized data comprises one or more of: geolocation data, electronic mail, text messages, social media data, photographs and photo albums, location tracking history, shopping and purchasing records, voicemail, tracking data including cookies, and any other personal data stored on the user device not included in the selected personal identification documents.

The computing apparatus is communicatively coupled to an authorized entity registry storing registration records associated with a plurality of authorized third parties. The one or more processors are further configured to execute the set of instructions to: register the authorized third party with the authorized entity registry by storing identification information and authorization credentials associated with the authorized third party, query the authorized entity registry upon receiving the access request to retrieve a registration status associated with the authorized third party, verify, based on the retrieved registration status, whether the authorized third party is authorized to request access to the protected accessible data of the user, and present the access request on the user device only upon successful verification of the registration status of the authorized third party.

The computing apparatus comprises one or more communication interfaces configured to receive the access request from the authorized third party through one or more of: a physical proximity interaction, a network interface associated with a network-based application, a browser communication module associated with a web browser interface, or an application programming interface (API) gateway associated with an external computing system. The one or more processors are further configured to transmit the selected personal identification documents and the one or more specific data attributes to the authorized third party through a corresponding one of the one or more communication interfaces based on a type of the received access request.

The one or more processors are further configured to: automatically terminate an access session associated with the authorized third party upon completion of access to the selected personal identification documents or the one or more specific data attributes, revoke one or more active access authorizations associated with the access session, and lock access to the protected accessible data on the user device until the user is re-authenticated using the one or more authorization credentials, irrespective of whether the user manually locks the user device.

The one or more processors are further configured to: generate one or more cryptographic signatures associated with the selected personal identification documents and the one or more specific data attributes, encrypt the selected personal identification documents and the one or more specific data attributes prior to transmission to the authorized third party, and transmit, through the one or more secure communication interfaces, the encrypted selected personal identification documents and the one or more specific data attributes together with the one or more cryptographic signatures, such that the authorized third party is enabled to verify authenticity of transmitted data while preventing unauthorized interception or access to underlying document data.

The one or more processors are configured to mask or redact one or more portions of the selected personal identification documents based on selected one or more data attributes prior to transmission to the authorized third party.

The one or more processors are configured to determine, based on selected one or more data attributes of the selected personal identification documents, whether the user satisfies a requested condition in the access, and transmit or disclose to the authorized third party only a result of the determination while withholding remaining data attributes of the selected personal identification documents.

The one or more processors are configured to restrict access to selected one or more data attributes of selected personal identification documents to a predefined access duration or an active communication session associated with the access request, and to terminate access to the data attributes upon expiration of the predefined access duration or termination of the communication session.

According to another aspect, the present disclosure provides a computer implemented method of electronically communicating protected accessible data of a user to an authorized third party, comprising steps of: rendering, on the user device, a user interface configured to receive protected accessible data associated with the user, the protected accessible data comprising a plurality of personal identification documents of the user, storing the protected accessible data in a database, generating, for each of the plurality of personal identification documents of the user, one or more authorization credentials comprising: an access code, a personal identification number (PIN), a password, a biometric authentication, or any combination thereof, to enable an authorized third party to access the selected personal identification documents, receiving an access request for the protected accessible data of the user from the authorized third party for providing one or more services to the user, enabling the user to select one or more of the plurality of personal identification documents for viewing by the authorized third party, enabling the user to select one or more data attributes from the selected personal identification documents for disclosure to the authorized third party while withholding remaining data attributes of the selected personal identification documents from the authorized third party, and enabling the user to provide authorization by providing one or more authorization credentials, for enabling the authorized third party to access the selected personal identification documents while preventing access to unauthorized data.

According to yet another aspect, the present disclosure provides one or more non-transitory computer-readable storage mediums for electronically communicating protected accessible user data to an authorized third party, the one or more non-transitory computer-readable storage mediums storing computer-executable instructions for controlling one or more computing systems to execute a method of electronically communicating protected accessible data of the user to the authorized third party.

The system and method of the present disclosure are advantageous in that they enable secure and controlled communication of protected accessible data of the user to the authorized third party while preventing unauthorized access to unrelated or sensitive personal information stored on the user device. The present disclosure further enables selective disclosure of only user-approved personal identification documents and specific data attributes required for a requested service, thereby reducing unnecessary exposure of personal data. The system further improves privacy protection by masking, redacting, or withholding non-required data attributes and by enabling determination of eligibility, qualification, status, or authorization conditions without revealing underlying sensitive information. Further, the present disclosure enhances security and authenticity of transmitted information through one or more authorization credentials including multi-factor authentication mechanisms comprising access codes, passwords, PINs, biometric authentication, or combinations thereof, together with cryptographic signatures, encrypted communications, session-based access control, automatic access termination, and re-authentication mechanisms. The present disclosure additionally provides interoperability across multiple communication environments including physical proximity interactions, network-based applications, browser interfaces, and application programming interfaces, thereby improving flexibility, reliability, and efficiency in secure electronic data sharing between users and authorized third parties.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is an exemplary block diagram illustrating a system for electronically communicating protected accessible user data to an authorized third party in accordance with the present disclosure.

FIG. 2 is an exemplary block diagram illustrating one or more modules of a computing apparatus of FIG. 1 in accordance with the present disclosure.

FIGS. 3A-3B are exemplary flow diagrams illustrating a method for electronically communicating protected accessible user data to an authorized third party in accordance with the present disclosure.

FIG. 4 illustrates a general computer architecture that can be appropriately configured to implement components disclosed in accordance with various embodiments of the present invention.

Similar or corresponding reference numerals are used throughout the several views of the accompanying drawings to designate identical or corresponding elements and features of the present disclosure.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “include” and/or “including,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. A system and method for electronically communicating protected accessible user data to an authorized third party is discussed herein. In the following description, for purposes of explanation, numerous specific details are set forth in order to provide a thorough understanding of the present invention. It will be evident, however, to one skilled in the art that the present invention may be practiced without these specific details. The present disclosure is to be considered as an exemplification of the invention and is not intended to limit the invention to the specific embodiments illustrated by the figures or description below. The present invention will now be described by referencing the appended figures representing preferred embodiments.

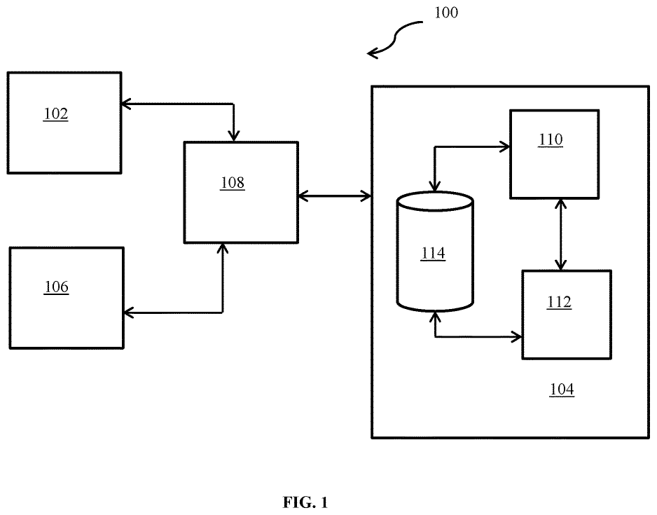

FIG. 1 is an exemplary block diagram illustrating a system 100 for electronically communicating protected accessible user data to an authorized third party in accordance with the present disclosure. The system 100 includes a user device 102 associated with a user, a computing apparatus 104, and a third party device 106 associated with an authorized third party. The user device 102 and the third party device 106 are communicatively coupled with the computing apparatus 104 through a network 108. The user device 102 may comprise, for example, a mobile phone, a smartphone, a tablet, a laptop computer, a desktop computer, a wearable electronic device, or any other electronic device capable of transmitting, receiving, and displaying data. The third party device 106 may comprise a computing terminal, mobile device, verification terminal, point-of-service device, server system, or any electronic device associated with the authorized third party and configured to receive selectively disclosed user data. The authorized third party may comprise, for example, a government agency, law enforcement authority, healthcare provider, banking or financial institution, employer, educational institution, hotel operator, transportation authority, insurance provider, merchant establishment, or any other entity authorized to request access to one or more user data attributes or verification results.

The computing apparatus 104 comprises one or more processors 112, a memory 110 storing a set of computer-executable instructions, and a database 114 configured to store user-related data, access policies, verification records, authentication data, transaction logs, or combinations thereof. The one or more processors 112 are configured to execute the set of instructions to facilitate secure electronic communication of protected accessible user data to the authorized third party while restricting disclosure of unauthorized or unnecessary information. The one or more processors 112 may comprise microprocessors, controllers, processing units, or any programmable logic circuitry configured to execute the set of instructions for performing operations associated with secure communication and selective disclosure of protected accessible user data. The memory 110 may comprise volatile memory, non-volatile memory, cache memory, storage devices, or combinations thereof, configured to store the set of instructions, user information, configuration parameters, authentication credentials, and other operational data associated with the system 100.

The network 108 may comprise one or more communication networks, including but not limited to a cellular communication network, wireless network, local area network (LAN), wide area network (WAN), the Internet, Bluetooth network, near-field communication (NFC) network, or combinations thereof, configured to enable data communication between the user device 102, the computing apparatus 104, and one or more external systems associated with the authorized third party.

The processors 112 are configured to generate and present a user interface on the user device 102 to facilitate interaction between the user and the computing apparatus 104. The user interface may be presented through a mobile application, a web-based application, a browser interface, a dedicated software application, or any graphical user interface executable on the user device 102. The interface is configured to facilitate the user to provide, upload, register, manage, review, and selectively authorize disclosure of protected accessible data associated with the user.

The processors 112 are configured to register the user by creating a user profile and generating a unique identifier associated with the user. The user profile may include user identification information, authentication credentials, personal identification documents, verification records, access preferences, consent settings, and service eligibility information associated with the user. The unique identifier may comprise a system-generated identification code, encrypted token, digital identity reference, cryptographic key identifier, decentralized identifier (DID), or any machine-readable identifier configured to uniquely associate the user with the computing apparatus 104. In some embodiments, the interface may further enable the user to input authentication credentials to interact with the computing apparatus 104. The authentication credentials may comprise a username, password, personal identification number (PIN), one-time password (OTP), biometric credential, cryptographic key, digital certificate, security token, device-based credential, or combinations thereof.

The processors 112 are further configured to verify the user identification information utilizing certificates associated with the unique identifier of the user. In some embodiments, the user verification is performed by a central registration system. The processors 112 are further configured to provide the plurality of services to the user and/or authorized third party upon verification of the identification information using encryption. The access to the plurality of services is limited based on the user profile.

The user interface is configured to receive protected accessible data associated with the user. The protected accessible data comprises a plurality of personal identification documents of the user. The plurality of personal identification documents includes, but is not limited to, driver's license, motor vehicle insurance document, registration document of a motor vehicle, passport or travel visas, domestic or international travel documents, immunization records, identity verification documents, voter registration document, health insurance document, age verification documents and rental contracts. In some embodiments, the personal identification document comprises information associated with one or more eligibility, qualification, status, or authorization criteria. The protected accessible data may apply to the entire personal identification documents of the user. In some embodiments, the protected accessible data of the user is obtained through an external device. Further, each time access to the protected accessible data is initiated through the user interface, the user is required to authenticate identity using one or more authentication credentials prior to permitting access to the protected accessible data. The processors 112 are configured to store the protected accessible data in the database 114. The one or more processors 112 are configured to securely store the protected accessible data in the database 114. In some embodiments, the protected accessible data is stored in an encrypted form to prevent unauthorized access, modification, disclosure, or duplication of the protected accessible data. The database 114 may further store metadata associated with the protected accessible data, including document type information, verification status, issuance details, expiration information, access permissions, consent records, authentication logs, and transaction history associated with disclosure of the protected accessible data.

The processors 112 are further configured to generate, for each of the plurality of personal identification documents of the user. The one or more authorization credentials may comprise an access code, personal identification number (PIN), password, one-time password (OTP), cryptographic token, digital key, biometric authentication credential, facial recognition input, fingerprint recognition input, iris recognition input, voice authentication input, device-based authentication credential, or any combination thereof.

In an embodiment, the one or more authorization credentials for each personal identification documents are generated dynamically in response to an access request received from the authorized third party and are associated with predefined access permissions, access duration parameters, authentication requirements, or disclosure limitations corresponding to the selected personal identification documents. The one or more processors 112 are configured to validate the generated authorization credentials prior to permitting the authorized third party to access the selected personal identification documents or one or more authorized data attributes associated therewith.

The one or more processors 112 are further configured to store, within the database 114, the generated authorization credentials in association with each corresponding personal identification document. For example, a first authorization credential may be associated with a passport document, a second authorization credential may be associated with a driver's license, and a third authorization credential may be associated with a healthcare identification document, such that access to each personal identification document is independently controlled based on the corresponding authorization credential and user-defined access permissions.

In an embodiment, the authorization credentials may further comprise biometric authentication credentials including fingerprint recognition, facial recognition, iris recognition, retina scan authentication, palm-vein recognition, hand geometry recognition, voice recognition, signature recognition, behavioral biometric authentication, gait recognition, or combinations thereof, configured to verify the identity of the user or the authorized third party prior to permitting access to the corresponding personal identification document. For example, access to a passport document may require successful facial recognition authentication of the user, access to a healthcare identification document may require fingerprint verification, and access to a financial identification document may require a combination of iris recognition.

In some embodiments, the one or more processors 112 are configured to implement multi-factor authentication by requiring a combination of two or more authentication factors prior to permitting access to the corresponding personal identification document. The multi-factor authentication may include a combination of a knowledge-based authentication factor, a possession-based authentication factor, and a biometric authentication factor. For example, access to a passport document may require entry of a password and successful facial recognition authentication, access to a healthcare identification document may require fingerprint verification in combination with a one-time password (OTP), and access to a financial identification document may require iris recognition together with device-based authentication prior to permitting disclosure of the corresponding protected accessible data to the authorized third party.

The processors 112 are configured to receive an access request for the protected accessible data of the user from the third party device 106 for providing one or more services to the user. The access request may identify one or more requested personal identification documents, user attributes, verification results, eligibility information, or authentication data required by the authorized third party for performing the one or more services. In an embodiment, the access request may be received through a mobile application, web-based platform, application programming interface (API), verification terminal, point-of-service device, kiosk, near-field communication (NFC) interaction, barcode or QR-code scan, wireless communication session, or any secure communication channel associated with the authorized third party. The one or more services may include identity verification services, healthcare services, financial transaction services, travel authorization services, hotel check-in services, employment verification services, educational verification services, insurance verification services, age-restricted access services, governmental services, law enforcement verification services, or regulatory compliance services. By way of example, the authorized third party may request verification of age for providing access to an age-restricted service, request insurance eligibility information for healthcare treatment, request identity verification for financial account access, or request travel identification information for transportation or immigration processing.

In some embodiments, the one or more processors 112 are configured to determine whether the access request satisfies one or more authorization conditions associated with the user profile, user consent settings, authentication requirements, access policies, geographic restrictions, service eligibility criteria, or regulatory compliance requirements prior to permitting access to the requested protected accessible data.

The computing apparatus 104 is communicatively coupled to an authorized entity registry storing registration records associated with a plurality of authorized third parties. The authorized entity registry may comprise a centralized registry database, distributed registry system, governmental verification repository, regulatory compliance database, enterprise authentication platform, or any trusted registration infrastructure configured to maintain authorization information associated with the plurality of authorized third parties. The registration records may include entity identification information, organization credentials, licensing information, service classifications, digital certificates, authentication credentials, authorization levels, geographic restrictions, regulatory approvals, transaction history, and access privileges associated with the plurality of authorized third parties.

In an embodiment, the one or more processors 112 are configured to validate authenticity of the authorized third party prior to registration by communicating with one or more external verification systems, governmental databases, financial verification networks, healthcare verification infrastructures, or regulatory compliance systems. For example, a healthcare provider may be validated against a medical licensing authority database, a banking institution may be validated against a financial regulatory registry, and a governmental agency may be validated against an official government authorization database. The one or more processors 112 are further configured to query the authorized entity registry upon receiving the access request to retrieve a registration status associated with the authorized third party. The registration status may indicate whether the authorized third party is active, verified, suspended, expired, restricted, revoked, or otherwise authorized to request access to the protected accessible data associated with the user. The one or more processors 112 are further configured to verify, based on the retrieved registration status, whether the authorized third party is authorized to request access to the protected accessible data of the user. In some embodiments, the verification further includes determining whether the requested protected accessible data corresponds to a permitted service category, predefined authorization scope, user consent setting, geographic restriction, or regulatory compliance requirement associated with the authorized third party. Upon successful verification of the registration status of the authorized third party, the one or more processors 112 are configured to present the access request on the user device 102 through the user interface.

In some embodiments, the one or more processors 112 are further configured to block, reject, flag, or quarantine the access request when the registration status indicates that the authorized third party is unverified, suspended, unauthorized, expired, or associated with suspicious activity, thereby preventing unauthorized access to the protected accessible data of the user.

The one or more processors 112 are further configured to enable the user, through the user interface presented on the user device 102, to selectively control disclosure of the protected accessible data to the authorized third party. In particular, the one or more processors 112 are configured to enable the user to select one or more of the plurality of personal identification documents for viewing by the authorized third party. In an embodiment, the user interface may present the plurality of personal identification documents and corresponding data attributes through selectable interface elements including check boxes, toggle controls, radio buttons, dropdown menus, selectable icons, consent sliders, permission tabs, or other graphical selection controls enabling the user to individually select, approve, restrict, or customize disclosure of one or more personal identification documents and associated data attributes.

The one or more processors 112 are further configured to enable the user to selectively choose one or more data attributes from the selected personal identification documents for disclosure to the authorized third party while withholding remaining data attributes contained within the selected personal identification documents. The one or more data attributes may include a name, photograph, age verification status, date of birth, address, nationality, employment status, insurance eligibility status, educational qualification, document validity status, or any other verifiable attribute associated with the user.

In an embodiment, the one or more processors 112 are configured to perform selective masking, redaction, tokenization, anonymization, or attribute-based filtering of the selected personal identification documents such that only the user-authorized data attributes are accessible to the authorized third party. For example, the system 100 may permit disclosure of only an age verification result confirming that the user is above a predefined age threshold while withholding the residential address, identification number, and other unrelated information contained within the selected personal identification document. Similarly, the system 100 may disclose only insurance eligibility confirmation to a healthcare provider without disclosing unrelated financial or identity information associated with the user.

In an embodiment, the one or more processors 112 are configured to associate the access authorization with an access duration parameter defining a permitted access time for the authorized third party to access the selected personal identification documents and the one or more specific data attributes. The access duration parameter may be defined manually by the user through the user interface or may be automatically determined by the one or more processors 112 based on a service type, verification requirement, security policy, regulatory requirement, transaction category, or predefined access rule associated with the authorized third party.

In an embodiment, the user interface may enable the user to define the permitted access time by selecting one or more predefined duration options, entering a custom access duration, selecting an expiration time, or enabling one-time access through selectable interface elements including check boxes, toggle controls, dropdown menus, or timer-based authorization controls. For example, the user may permit a healthcare provider to access insurance eligibility information for a duration of thirty minutes, permit a hotel operator to access age verification information for a single check-in session, or permit a financial institution to access identification information only for completion of an electronic know-your-customer (e-KYC) verification process.

In some embodiments, the one or more processors 112 are further configured to automatically terminate the access authorization upon expiration of the permitted access time, completion of the requested service, termination of a communication session, detection of inactivity, or occurrence of a predefined security condition. Upon termination of the access authorization, the one or more processors 112 may further revoke associated session tokens, authentication credentials, cryptographic keys, API access permissions, browser-based credential sessions, or temporary access links associated with the authorized third party.

The one or more processors 112 are further configured to enable the user to provide authorization for disclosure of the selected personal identification documents and the selected one or more data attributes by providing one or more authorization credentials for each selected personal identification documents.

Upon successful verification of the one or more authorization credentials, the one or more processors 112 are configured to enable the authorized third party to access only the selected personal identification documents and the selected one or more data attributes associated therewith, while preventing access to unauthorized, unrelated, masked, restricted, or non-selected data associated with the user. In some embodiments, the access may further be restricted based on a predefined access duration, transaction-specific authorization, geographic restriction, service category, device authentication status, or user-defined access policy. Unauthorized data may include, but not limited to geolocation data, email, text messages, social media, pictures & photo albums, location tracking and history, shopping and purchasing records, voicemail, tracking data such as cookies, and any other personal data. The system 100 is agnostic to device hardware, operating system, or other software.

In some embodiments, the one or more processors 112 are configured to determine, based on selected one or more data attributes of the selected personal identification documents, whether the user satisfies a requested condition in the access, and transmit or disclose to the authorized third party only a result of the determination while withholding remaining data attributes of the selected personal identification documents. For example, when the authorized third party 112 requests age verification for entry into a restricted venue or for purchase of an age-restricted product or service, the one or more processors 112 analyze one or more data attributes associated with a government-issued identification document of the user, including a date-of-birth attribute, to determine whether the user satisfies a predefined minimum age requirement. The one or more processors 112 thereafter transmit to the authorized third party only a verification result indicating that the user satisfies or does not satisfy the minimum age requirement, while withholding the actual date of birth, document identification number, residential address, photograph, and other personal identification information contained within the selected personal identification document.

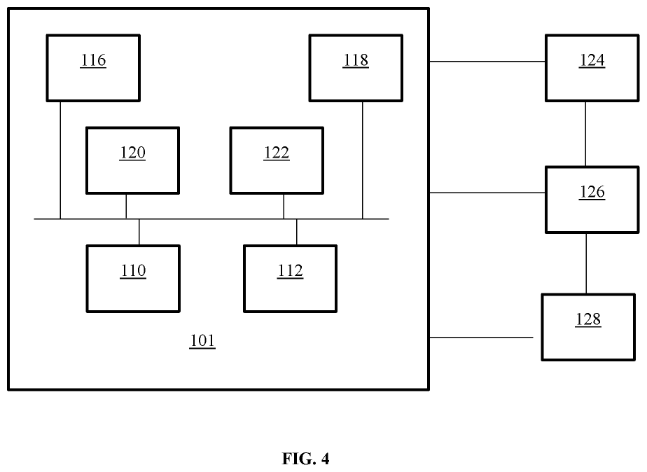

The computing apparatus 104 further comprises one or more communication interfaces 118 (seen in FIG. 4) configured to receive the access request from the authorized third party through one or more communication channels including: a physical proximity interaction, a network interface associated with a network-based application, a browser communication module associated with a web browser interface, or an application programming interface (API) gateway associated with an external computing system. The one or more communication interfaces 118 may further comprise near-field communication (NFC) interfaces, Bluetooth communication interfaces, wireless communication modules, QR-code scanning interfaces, mobile application interfaces, cloud-based communication interfaces, web authentication modules, secure browser sessions, token exchange interfaces, or API-based credential exchange infrastructures configured to support both in-person and remote identity verification interactions.

In an embodiment, the physical proximity interaction may include presentation of the protected accessible data through a user-controlled digital wallet interface during an in-person interaction with an authorized third party, including interactions with a transportation security authority representative, law enforcement officer, hospitality service provider, retail merchant, age-restricted service provider, or healthcare representative. For example, the protected accessible data may be transmitted through NFC communication, Bluetooth pairing, QR-code exchange, or device-to-device wireless communication during a physical verification session.

In another embodiment, the one or more communication interfaces 118 are configured to support remote or non-physical identity verification interactions through web browser interfaces, mobile applications, cloud-based service platforms, and external computing systems. The browser communication module and the API gateway may be configured to facilitate secure presentation, verification, and selective disclosure of the protected accessible data through standardized credential exchange protocols, digital wallet communication frameworks, browser-based authentication sessions, or application-to-application credential sharing mechanisms.

The one or more processors 112 are further configured to transmit the selected personal identification documents and the one or more specific data attributes to the authorized third party through a corresponding one of the one or more communication interfaces 118 based on a type of the received access request. For example, when the access request is received through a physical proximity interaction, the selected personal identification documents may be transmitted through NFC communication or QR-code exchange, whereas when the access request is received through a web browser interface or network-based application, the selected personal identification documents and the one or more specific data attributes may be transmitted through encrypted browser sessions, secure API transactions, tokenized credential exchanges, cloud-based verification sessions, or digitally signed credential presentation protocols.

In some embodiments, the one or more processors 112 are configured to support standards-based digital credential presentation and verification protocols for enabling interoperability between the computing apparatus 104 and external computing systems associated with the authorized third party. The standards-based digital credential presentation and verification protocols may include browser-based credential exchange protocols, mobile application credential exchange frameworks, decentralized identity verification protocols, verifiable credential presentation protocols, digital wallet interoperability standards, or application programming interface (API)-based authentication frameworks configured to support remote identity verification, online account authentication, healthcare patient identification, financial institution verification, electronic know-your-customer (e-KYC) verification, e-commerce identity verification, and secure access authorization services.

In some embodiments, the authorized third party may comprise an online commerce platform, healthcare management platform, financial institution platform, transportation service platform, pharmacy service platform, telehealth platform, insurance verification system, or enterprise authentication platform configured to receive the selected personal identification documents or verification results through a web browser interface, mobile application interface, or API-based credential exchange session without requiring physical interaction between the user and the authorized third party

The one or more processors 112 are further configured to automatically terminate an access session associated with the authorized third party upon completion of access to the selected personal identification documents or the one or more specific data attributes, revoke one or more active access authorizations associated with the access session, and lock access to the protected accessible data on the user device until the user is re-authenticated using the one or more authorization credentials, irrespective of whether the user manually locks the user device. Further, after the selected personal identification documents are accessed by the authorized third party, the user device 102 may be automatically reset to a secured state requiring the user to authenticate identity before any protected features, applications, or data associated with the protected accessible data become accessible through the user device 102. For example, when the user temporarily provides access to a driver's license and vehicle registration document to a law enforcement officer or rental service provider acting as the authorized third party, the one or more processors automatically terminate the access session immediately after completion of document verification. Thereafter, the protected accessible data is locked, active access permissions are revoked, and the user device 102 requires re-authentication by the user before access to any protected accessible data or associated secure functionalities is restored.

In an embodiment, upon receiving user selection of one or more personal identification documents or one or more specific data attributes for disclosure to the authorized third party, the one or more processors 112 generate a cryptographic hash corresponding to the selected personal identification documents and the one or more specific data attributes. The one or more processors 112 further generate one or more cryptographic signatures by applying a private cryptographic key associated with the computing apparatus or the user device 102 to the generated cryptographic hash. The generated cryptographic signatures are configured to enable the authorized third party to verify authenticity and integrity of the transmitted data using a corresponding public cryptographic key.

In some embodiments, prior to transmission, the one or more processors 112 encrypt the selected personal identification documents and the one or more specific data attributes using one or more encryption techniques comprising symmetric encryption, asymmetric encryption, transport-layer encryption, or combinations thereof. In one embodiment, a temporary session encryption key is generated for a communication session associated with the authorized third party. The selected personal identification documents and the one or more specific data attributes are encrypted using the temporary session encryption key, and the temporary session encryption key is further encrypted using a public cryptographic key associated with the authorized third party.

The encrypted selected personal identification documents, the encrypted one or more specific data attributes, and the one or more cryptographic signatures are transmitted through the one or more secure communication interfaces to the authorized third party. Upon receipt, the authorized third party decrypts the encrypted data using a corresponding private cryptographic key and verifies the one or more cryptographic signatures using the corresponding public cryptographic key to confirm authenticity, integrity, and origin of the transmitted data while preventing unauthorized interception, tampering, duplication, or access to underlying document data during transmission.

For example, when the user selectively discloses a driver's license and an age verification attribute to a rental service provider acting as the authorized third party, the one or more processors 112 generate a cryptographic signature associated with the disclosed information and encrypt the disclosed information prior to transmission through a secure communication session. The rental service provider is thereby enabled to verify that the disclosed information originated from an authenticated source and remained unaltered during transmission, while unauthorized third parties are prevented from accessing or intercepting the underlying personal identification information.

In some embodiments, the user interface is customized based on a region associated with a location of the user. The region determines a type of the protected accessible data to be displayed through the interface for a respective authorized third party based on regional requirements, jurisdictional regulations, language preferences, document formats, or verification standards associated with the region. In some embodiments, the user interface dynamically prioritizes or filters the plurality of personal identification documents according to a type of transaction, service request, or verification requirement associated with the authorized third party.

The one or more processors 112 are further configured to track access, disclosure, transmission, and usage activities associated with the protected accessible data displayed through the interface, and to store a transaction history in the database 114 corresponding to interactions between the user and the authorized third party. The transaction history comprises one or more of: an identity of the authorized third party, a category of accessed protected accessible data, one or more disclosed specific data attributes, timestamp information, geographic location information, communication channel information, duration of access, authentication events, verification outcomes, and access revocation events.

The user interface further enables the user to define one or more configurable access-control settings associated with the protected accessible data. The one or more configurable access-control settings comprise at least one of: a duration of access, a number of permitted uses associated with each granted access code, categories of potentially accessible protected accessible data, document-specific disclosure permissions, attribute-level disclosure permissions, regional disclosure restrictions, authentication requirements, expiration conditions, device-specific access limitations, and automatic revocation conditions associated with granted access authorizations.

In some embodiments, the one or more processors 112 are configured to automatically revoke access permissions upon expiration of the duration of access, exhaustion of the permitted number of uses, detection of suspicious activity, or completion of a predefined verification transaction associated with the authorized third party. Further, the user interface enables the user to selectively modify, suspend, renew, or permanently revoke previously granted access permissions in real time through the user device 102.

For example, when the user travels to a foreign jurisdiction and interacts with a hotel operator acting as the authorized third party, the user interface may automatically prioritize display of passport information, travel visas, and regional travel verification documents required within the jurisdiction while restricting access to unrelated personal identification documents. The user may configure the interface to permit the hotel operator to access only identity verification information and temporary address confirmation for a predefined duration of twenty-four hours and for a single verification transaction. The one or more processors 112 record the transaction in the database 114 together with timestamp information, geographic location information, and details of the disclosed specific data attributes. Upon completion of the hotel check-in process or expiration of the predefined duration, the granted access authorization is automatically revoked and the protected accessible data is locked until re-authentication by the user.

In some embodiments, the computing apparatus 104 is implemented as one or more local computing systems, one or more cloud-based computing systems, one or more distributed computing systems, or combinations thereof. In certain embodiments, the computing apparatus 104 comprises a hybrid computing architecture including a local processing component associated with the user device 102 and a remote cloud computing infrastructure configured to perform secure storage, authentication, encryption, synchronization, transaction logging, access management, or verification operations associated with the protected accessible data. The cloud-based computing systems may comprise one or more virtual servers, containerized computing environments, distributed databases, or scalable network-accessible processing resources communicatively coupled through one or more communication networks. In some embodiments, sensitive authentication operations and temporary access-control operations are performed locally on the user device 102, while archival storage, backup operations, synchronization functions, and large-scale verification processing are performed through the cloud-based computing systems.

The computing apparatus 104 facilitates launching a digital vault configured to securely manage protected accessible data associated with the user and stored within the database 114. The digital vault is accessible through an application executed on the user device 102 and operated by the computing apparatus 104 to control authentication, encryption, access authorization, selective disclosure, and transaction management associated with the protected accessible data. The digital vault enables the user to selectively disclose one or more personal identification documents or one or more specific data attributes to an authorized third party in accordance with user-defined access-control settings.

Upon launching the digital vault, the user authenticates identity using one or more authentication credentials comprising at least one of: a password, personal identification number (PIN), biometric authentication credential, one-time password (OTP), or multi-factor authentication mechanism. Following successful authentication, the user selectively grants access to one or more personal identification documents or one or more specific data attributes associated with the protected accessible data.

In some embodiments, the user unlocks the user device 102 and provides an access code, temporary authorization credential, dynamically generated verification token, machine-readable code, near-field communication (NFC)-based credential, or secure session identifier to the authorized third party to facilitate controlled access to the selected protected accessible data. The authorized third party is thereby enabled to access only the protected accessible data permitted by the user while restricting access to unrelated documents, applications, device functions, or personal information associated with the user device 102.

The digital vault further enforces one or more user-defined security criteria associated with disclosure of the protected accessible data. The one or more security criteria comprise at least one of: duration-based access restrictions, session-based access restrictions, geographic restrictions, usage-count limitations, device-specific access limitations, attribute-level disclosure restrictions, automatic session termination conditions, authentication renewal requirements, and automatic access revocation conditions. The computing apparatus 104 continuously monitors access activities associated with the authorized third party and automatically terminates or restricts access upon detection of expiration conditions, unauthorized activity, policy violations, or completion of a predefined verification transaction.

Upon termination of an access session, exiting of the application, locking or restarting of the user device 102, expiration of an authorized access duration, or detection of unauthorized activity, the protected accessible data is automatically secured in accordance with the user-defined security criteria. In some embodiments, active access authorizations associated with the authorized third party are revoked and the protected accessible data becomes inaccessible until the user is re-authenticated using the one or more authentication credentials.

For example, the user may temporarily provide a hotel receptionist acting as the authorized third party with access to a passport and travel verification document through the digital vault using a dynamically generated QR code valid for a single transaction and a predefined duration of five minutes. The hotel receptionist is thereby enabled to verify identity and travel authorization information without accessing unrelated personal information stored on the user device 102. Upon completion of the verification transaction, expiration of the predefined duration, exiting of the application, or restarting of the user device 102, the digital vault automatically revokes the granted access authorization, terminates the access session, and secures the protected accessible data from further access until re-authentication by the user.

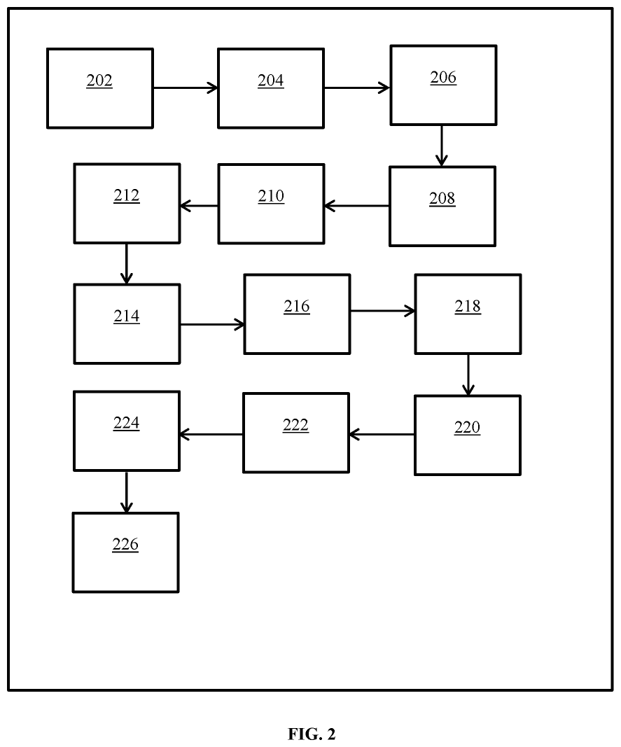

With reference to FIG. 1, FIG. 2 is an exemplary block diagram illustrating one or more modules of the computing apparatus 104 of FIG. 1 in accordance with the present disclosure. The one or more processors 112 are configured to execute a set of instructions stored in the memory 110 to implement the one or more functional modules for electronically communicating protected accessible user data to an authorized third party. The one or more functional modules includes an interface presenting module 202, a user registration module 204, a third party registration module 206, a protected accessible data receiving module 208, an authorization credentials generation module 210, an access request receiving module 212, a verification module 214, a selection module 216, a masking module 218, an access parameter defining module 220, an encryption module 222, a third party access authorization module 224, and a session termination module 226. The interface presenting module 202 is configured to generate and present, through the user device 102, one or more user interfaces enabling the user and the authorized third party to interact with the computing apparatus 104 for registration, authentication, access authorization, selective disclosure, and verification of protected accessible data. The interface presenting module 202 is further configured to customize interface elements based on a region, transaction type, user preferences, or access permissions associated with the authorized third party.

The user registration module 204 is configured to register the user with the computing apparatus 104 by receiving user identification information, authentication credentials, personal profile information, device association information, and one or more personal identification documents associated with the protected accessible data. The user registration module 204 is further configured to generate and store user account information and user-defined access-control settings within the database 114.

The third party registration module 206 is configured to register the authorized third party with an authorized entity registry by receiving organization information, verification credentials, authorization identifiers, communication interface information, and access-policy information associated with the authorized third party.

The protected accessible data receiving module 208 is configured to receive, import, capture, synchronize, or store protected accessible data associated with the user from the user device 102 or one or more external devices, external databases, cloud-based repositories, or document sources. The protected accessible data receiving module 208 is further configured to organize the protected accessible data into one or more personal identification documents for selective disclosure operations.

The authorization credentials generation module 210 is configured to generate one or more authorization credentials associated with disclosure of protected accessible data. The one or more authorization credentials comprise at least one of: an access code, a personal identification number (PIN), a password, a biometric authentication, or any combination thereof to facilitate controlled access by the authorized third party. In some embodiments, The one or more authorization credentials comprise access codes, temporary passwords, one-time passwords (OTPs), cryptographic tokens, session identifiers, machine-readable codes, dynamically generated QR codes, or near-field communication (NFC)-based credentials.

The access request receiving module 212 is configured to receive one or more access requests associated with protected accessible data from the third party device 106 through one or more communication interfaces. The access request receiving module 212 is further configured to identify requested personal identification documents, requested data attributes, requested verification conditions, access duration parameters, and communication channel information associated with the access request.

The verification module 214 is configured to authenticate the user and verify authorization status of the authorized third party prior to disclosure of protected accessible data.

The selection module 216 is configured to enable selective identification and disclosure of one or more personal identification documents and/or one or more specific data attributes associated with the protected accessible data in accordance with user-defined disclosure permissions and access-control settings. The selection module 216 is further configured to restrict disclosure of unrelated or unauthorized personal information associated with the user.

The masking module 218 is configured to conceal, redact, blur, anonymize, partially hide, or otherwise mask one or more portions of the protected accessible data prior to transmission or display to the authorized third party. The masking module 218 is further configured to selectively expose only authorized data attributes required for completion of a verification transaction while withholding remaining sensitive information.

The access parameter defining module 220 is configured to define, receive, manage, and enforce one or more access parameters associated with disclosure of protected accessible data to the authorized third party. The one or more access parameters comprise at least one of: a duration of access, a number of permitted access attempts or uses, session validity conditions, document-specific disclosure permissions, attribute-level disclosure permissions, geographic restrictions, device-specific access limitations, communication channel restrictions, authentication requirements, expiration conditions, automatic revocation conditions, and transaction-specific access limitations associated with the protected accessible data. The access parameter defining module 220 is further configured to communicate the defined access parameters to one or more other functional modules of the computing apparatus 104 to facilitate controlled disclosure, session monitoring, automatic access termination, and secure management of the protected accessible data.

The encryption module 222 is configured to encrypt the protected accessible data, generate cryptographic hashes and cryptographic signatures, establish secure communication sessions, and protect transmitted data against unauthorized interception, duplication, tampering, or access during storage and transmission operations associated with the protected accessible data.

The third party access authorization module 224 is configured to grant, monitor, modify, suspend, revoke, or terminate access authorizations associated with the authorized third party. The third party access authorization module 224 is further configured to enforce one or more access-control policies comprising duration limitations, usage-count limitations, session restrictions, geographic restrictions, authentication requirements, automatic revocation conditions, and re-authentication conditions associated with disclosure of the protected accessible data.

The session termination module 226 is configured to monitor, control, and terminate one or more access sessions associated with the authorized third party for accessing protected accessible data associated with the user. The session termination module 226 is further configured to automatically terminate an access session upon occurrence of one or more predefined termination conditions comprising expiration of an authorized access duration, completion of a verification transaction, exhaustion of a permitted number of uses, detection of unauthorized activity, user-initiated revocation, inactivity exceeding a predefined threshold duration, exiting of the application, locking or restarting of the user device 102, or violation of one or more access-control policies.

The session termination module 226 is further configured to revoke one or more active access authorizations associated with the terminated access session and prevent continued access to the protected accessible data by the authorized third party following termination of the access session. In some embodiments, the session termination module 226 communicates with the encryption module 222 and the third party access authorization module 224 to invalidate temporary authorization credentials, terminate secure communication sessions, disable active verification tokens, and secure the protected accessible data from further access until re-authentication by the user.

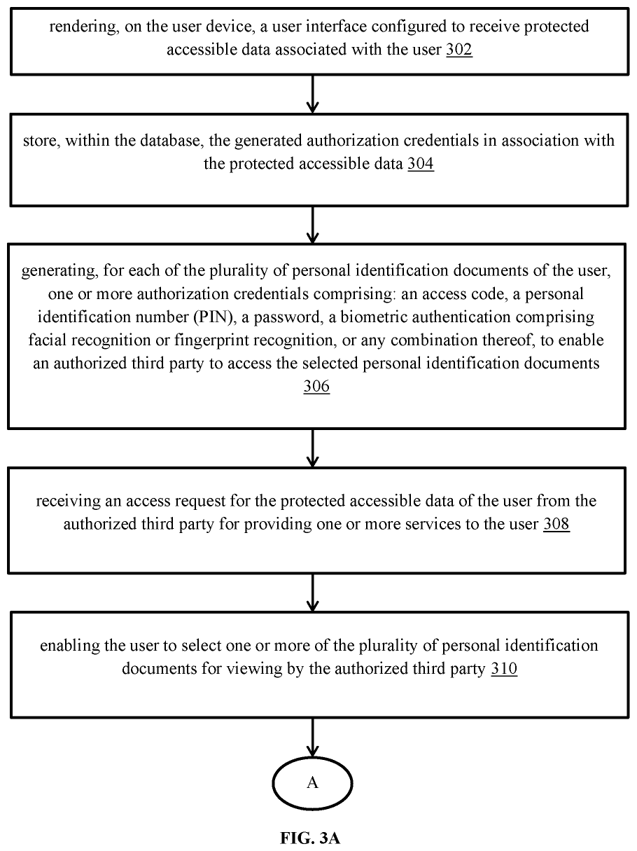

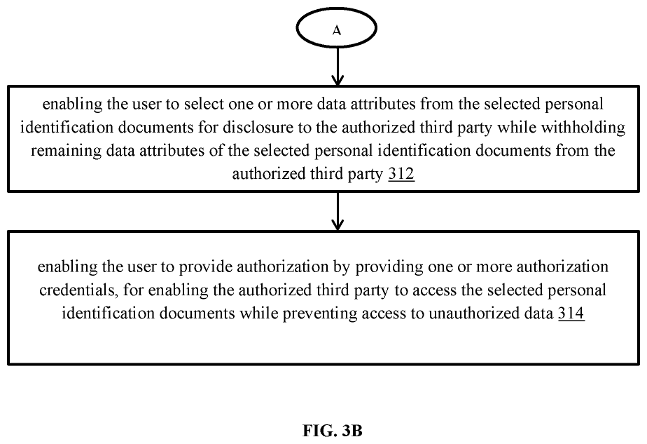

With reference to FIG. 1-2, FIGS. 3A-3B are exemplary flow diagrams illustrating a method for electronically communicating protected accessible user data to an authorized third party in accordance with the present disclosure. At step 302, the method includes rendering, on the user device 102, a user interface configured to receive protected accessible data associated with the user. At step 304, the method includes storing, within the database 114, the generated authorization credentials in association with the protected accessible data. At step 306, the method includes generating, for each of the plurality of personal identification documents of the user, one or more authorization credentials comprising: an access code, a personal identification number (PIN), a password, a biometric authentication comprising facial recognition or fingerprint recognition, or any combination thereof, to enable an authorized third party to access the selected personal identification documents. At step 308, the method includes receiving an access request for the protected accessible data of the user from the authorized third party for providing one or more services to the user. At step 310, the method includes enabling the user to select one or more of the plurality of personal identification documents for viewing by the authorized third party. At step 312, the method includes enabling the user to select one or more data attributes from the selected personal identification documents for disclosure to the authorized third party while withholding remaining data attributes of the selected personal identification documents from the authorized third party. At step 314, the method includes enabling the user to provide authorization by providing one or more authorization credentials, for enabling the authorized third party to access the selected personal identification documents while preventing access to unauthorized data. The method steps illustrated in FIGS. 3A-3B are exemplary in nature and are not limited to the specific sequence, operations, or functionalities expressly described herein. In some embodiments, one or more additional, optional, intermediate, parallel, repeated, reordered, or omitted operations may be performed without departing from the scope of the present disclosure. Further, the functionalities, features, configurations, security operations, access-control mechanisms, verification operations, encryption operations, selective disclosure operations, digital vault management operations, session management operations, transaction logging operations, authentication mechanisms, masking operations, and automatic access revocation operations described in connection with the system 100, the computing apparatus 104, and the one or more functional modules of FIG. 2 are equally applicable to the method of FIGS. 3A-3B and may be incorporated into one or more method steps, whether or not expressly illustrated in the flow diagrams.

In some embodiments, one or more method steps may be performed automatically by the computing apparatus 104 in response to predefined access conditions, user-defined security criteria, verification requirements, regional restrictions, transaction-specific requirements, or detected access events associated with the authorized third party. Further, the one or more method steps may be performed locally on the user device 102, remotely through one or more cloud-based computing systems, or through a hybrid computing architecture comprising both local and remote computing resources.

It shall be appreciated that the method illustrated in FIGS. 3A-3B may further include operations associated with launching and managing a digital vault, generating cryptographic signatures, encrypting protected accessible data, verifying authenticity of transmitted data, monitoring access sessions, generating transaction histories, dynamically modifying access permissions, masking one or more portions of protected accessible data, determining verification outcomes based on selected data attributes, and automatically terminating access sessions associated with the authorized third party.

With reference to FIG. 1-3B, FIG. 4 illustrates a general computer architecture of the computing apparatus 104 that can be appropriately configured to implement components disclosed in accordance with various embodiments of the present invention. The general computing apparatus 104 can include various common computing elements, such as a computer 101, a network 126, one or more remote computers 128, and a network storage 124. The computer 101 may be a server, a desktop computer, a laptop computer, a tablet computer or a mobile computing device. The computer 101 may include a processor 112, a main memory 110 and a system bus. The processor 112 may feature one or more processing units that can operate independently of each other. The main memory 110 may include volatile devices, non-volatile devices, or other random access memory devices. The computer 101 may feature secondary storage 122, consisting of one or more removable and/or non-removable storage units. These units house an operating system that manages various applications on the computer 101. The secondary storage 122 may also be used to store software configured to implement the components of the embodiments disclosed herein, which may be executed as one or more applications under the operating system. The computer 101 may also include a communication device(s) 118 through which the computer communicates with other devices, such as one or more remote computers 128, over wired and/or wireless computer networks 126. The communication device(s) 118 may communicate over but not limited to Wi-Fi, Bluetooth, ultra-wide band technology, and mobile telephone networks. The computer 101 may also access network storage 124 through computer network 126. The network storage 124 may include a network-attached storage device or cloud-based storage. The operating system and/or software may be stored in network storage 124. The computer 101 may have various input device(s) 116 for example, keyboard, mouse, touchscreen, camera, microphone, or a sensor, output device(s) 120, for example, a display, speakers or a printer. Storage devices 122, the communication device(s) 118, input devices 116 and output devices 120 may be integrated within a computer system or connected through various computer input/output interface devices.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A system for electronically communicating protected accessible data of a user to an authorized third party, comprising:
a user device associated with the user; and
a computing apparatus communicatively coupled to the user device, comprising a memory storing a set of instructions; and one or more processors configured to execute the set of instructions to
render, on the user device, a user interface configured to receive protected accessible data associated with the user, wherein the protected accessible data comprises a plurality of personal identification documents of the user;
generate, for each of the plurality of personal identification documents of the user, one or more authorization credentials comprising: an access code, a personal identification number (PIN), a password, a biometric authentication, or any combination thereof, to enable an authorized third party to access the selected personal identification documents;
store, within the database, the generated authorization credentials in association with the protected accessible data;
receive an access request for the protected accessible data of the user from the authorized third party for providing one or more services to the user;
enable the user to select one or more of the plurality of personal identification documents for viewing by the authorized third party;
enable the user to select one or more data attributes from the selected personal identification documents for disclosure to the authorized third party while withholding remaining data attributes of the selected personal identification documents from the authorized third party; and
enable the user to provide authorization by providing one or more authorization credentials, for enabling the authorized third party to access the selected personal identification documents with select one or more data attributes while preventing access to unauthorized data.

2. The system of claim 1, wherein the computing apparatus is communicatively coupled to an authorized entity registry storing registration records associated with a plurality of authorized third parties, and wherein the one or more processors are further configured to execute the set of instructions to:
register the authorized third party with the authorized entity registry by storing identification information and authorization credentials associated with the authorized third party;
query the authorized entity registry upon receiving the access request to retrieve a registration status associated with the authorized third party;
verify, based on the retrieved registration status, whether the authorized third party is authorized to request access to the protected accessible data of the user; and
present the access request on the user device only upon successful verification of the registration status of the authorized third party.

3. The system of claim 1, wherein the computing apparatus comprises one or more communication interfaces configured to receive the access request from the authorized third party through one or more of: a physical proximity interaction, a network interface associated with a network-based application, a browser communication module associated with a web browser interface, or an application programming interface (API) gateway associated with an external computing system; and wherein the one or more processors are further configured to transmit the selected personal identification documents and the one or more specific data attributes to the authorized third party through a corresponding one of the one or more communication interfaces based on a type of the received access request.

4. The system of claim 1, wherein the one or more processors are further configured to:
automatically terminate an access session associated with the authorized third party upon completion of access to the selected personal identification documents or the one or more specific data attributes;
revoke one or more active access authorizations associated with the access session; and
lock access to the protected accessible data on the user device until the user is re-authenticated using the one or more authorization credentials, irrespective of whether the user manually locks the user device.

5. The system of claim 3, wherein the one or more processors are further configured to:
generate one or more cryptographic signatures associated with the selected personal identification documents and the one or more specific data attributes;
encrypt the selected personal identification documents and the one or more specific data attributes prior to transmission to the authorized third party; and
transmit, through the one or more secure communication interfaces, the encrypted selected personal identification documents and the one or more specific data attributes together with the one or more cryptographic signatures, such that the authorized third party is enabled to verify authenticity of transmitted data while preventing unauthorized interception or access to underlying document data.

6. The system of claim 1, wherein the personal identification document comprises information associated with one or more eligibility, qualification, status, or authorization criteria.

7. The system of claim 1, wherein the one or more processors are configured to mask or redact one or more portions of the selected personal identification documents based on selected one or more data attributes prior to transmission to the authorized third party.

8. The system of claim 1, wherein the one or more processors are configured to determine, based on selected one or more data attributes of the selected personal identification documents, whether the user satisfies a requested condition in the access, and transmit or disclose to the authorized third party only a result of the determination while withholding remaining data attributes of the selected personal identification documents.

9. The system of claim 1, wherein the unauthorized data comprises one or more of: geolocation data, electronic mail, text messages, social media data, photographs and photo albums, location tracking history, shopping and purchasing records, voicemail, tracking data including cookies, and any other personal data stored on the user device not included in the selected personal identification documents.

10. The system of claim 1, wherein the one or more processors is configured to restrict access to selected one or more data attributes of selected personal identification documents to a predefined access duration or an active communication session associated with the access request, and to terminate access to the data attributes upon expiration of the predefined access duration or termination of the communication session.

11. A computer implemented method of electronically communicating protected accessible data
of a user to an authorized third party, comprising steps of:
rendering, on the user device, a user interface configured to receive protected accessible data associated with the user, wherein the protected accessible data comprises a plurality of personal identification documents of the user;
storing, within the database, the generated authorization credentials in association with the protected accessible data;
generating, for each of the plurality of personal identification documents of the user, one or more authorization credentials comprising: an access code, a personal identification number (PIN), a password, a biometric authentication, or any combination thereof, to enable an authorized third party to access the selected personal identification documents;
receiving an access request for the protected accessible data of the user from the authorized third party for providing one or more services to the user;
enabling the user to select one or more of the plurality of personal identification documents for viewing by the authorized third party;
enabling the user to select one or more data attributes from the selected personal identification documents for disclosure to the authorized third party while withholding remaining data attributes of the selected personal identification documents from the authorized third party; and
enabling the user to provide authorization by providing one or more authorization credentials, for enabling the authorized third party to access the selected personal identification documents while preventing access to unauthorized data.

12. The method of claim 11, further comprising the steps of:
registering the authorized third party with an authorized entity registry by storing identification information and authorization credentials associated with the authorized third party;
querying the authorized entity registry upon receiving the access request to retrieve a registration status associated with the authorized third party;
verifying, based on the retrieved registration status, whether the authorized third party is authorized to request access to the protected accessible data of the user; and
presenting the access request on the user device only upon successful verification of the registration status of the authorized third party.

13. The method of claim 1, further comprising the steps of:
receiving the access request from the authorized third party through one or more of: a physical proximity interaction, a network interface associated with a network-based application, a browser communication module associated with a web browser interface, or an application programming interface (API) gateway associated with an external computing system; and
transmitting the selected personal identification documents and the one or more specific data attributes to the authorized third party through a corresponding one of the one or more communication interfaces based on a type of the received access request.

14. The method of claim 11, further comprising the steps of:
automatically terminating an access session associated with the authorized third party upon completion of access to the selected personal identification documents or the one or more specific data attributes;
revoking one or more active access authorizations associated with the access session; and
locking access to the protected accessible data on the user device until the user is re-authenticated using the one or more authorization credentials, irrespective of whether the user manually locks the user device.

15. The method of claim 11, further comprising the steps of:
generating one or more cryptographic signatures associated with the selected personal identification documents and the one or more specific data attributes;
encrypting the selected personal identification documents and the one or more specific data attributes prior to transmission to the authorized third party; and
transmitting, through the one or more secure communication interfaces, the encrypted selected personal identification documents and the one or more specific data attributes together with the one or more cryptographic signatures, such that the authorized third party is enabled to verify authenticity of transmitted data while preventing unauthorized interception or access to underlying document data.

16. The method of claim 11, further comprising a step of masking or redacting one or more portions of the selected personal identification documents based on selected one or more data attributes prior to transmission to the authorized third party.

17. The method of claim 11, further comprising the steps of determining, based on selected one or more data attributes of the selected personal identification documents, whether the user satisfies a requested condition in the access, and transmitting or disclosing to the authorized third party only a result of the determination while withholding remaining data attributes of the selected personal identification documents.

18. The method of claim 11, wherein the unauthorized data comprises one or more of:
geolocation data, electronic mail, text messages, social media data, photographs and photo albums, location tracking history, shopping and purchasing records, voicemail, tracking data including cookies, and any other personal data stored on the user device not included in the selected personal identification documents.

19. The method of claim 11, further comprising the steps of restricting access to selected one or more data attributes of selected personal identification documents to a predefined access duration or an active communication session associated with the access request, and to terminate access to the data attributes upon expiration of the predefined access duration or termination of the communication session.

20. One or more non-transitory computer-readable storage mediums for electronically communicating protected accessible user data to an authorized third party, the one or more non-transitory computer-readable storage mediums storing computer-executable instructions for controlling one or more computing systems to:
render, on the user device, a user interface configured to receive protected accessible data associated with the user, wherein the protected accessible data comprises a plurality of personal identification documents of the user;
storing, within the database, the generated authorization credentials in association with the protected accessible data;
generate, for each of the plurality of personal identification documents of the user, one or more authorization credentials comprising: an access code, a personal identification number (PIN), a password, a biometric authentication, or any combination thereof, to enable an authorized third party to access the selected personal identification documents;
receive an access request for the protected accessible data of the user from the authorized third party for providing one or more services to the user;
enable the user to select one or more of the plurality of personal identification documents for viewing by the authorized third party;
enable the user to select one or more data attributes from the selected personal identification documents for disclosure to the authorized third party while withholding remaining data attributes of the selected personal identification documents from the authorized third party; and
enable the user to provide authorization by providing one or more authorization credentials, for enabling the authorized third party to access the selected personal identification documents while preventing access to unauthorized data.
